(19) United States
(12) Patent Application Publication
(10) Pub. No.: US 2017/0193256 A1
(43) Pub. Date: Jul. 6, 2017

(54) RFID TAG AND METHOD OF CONTROLLING THE SAME

(71) Applicant: Electronics and Telecommunications Research Institute, Daejeon (KR)

(72) Inventors: Jae Young JUNG, Daejeon (KR); Chan Won PARK, Daejeon (KR); Hyun Seok KIM, Jeonju-si (KR); Hyo Chan BANG, Daejeon (KR); Won Kyu CHOI, Daejeon (KR)

(73) Assignee: Electronics and Telecommunications Research Institute, Daejeon (KR)

(21) Appl. No.: 15/172,433

(22) Filed: Jun. 3, 2016

(30) Foreign Application Priority Data
Jan. 4, 2016 (KR) 10-2016-0000652

(51) Int. Cl. G06K 7/10; G06K 19/07

(52) U.S. Cl. CPC G06K 7/10158; G06K 19/0702; G06K 2007/10495

(57) ABSTRACT

Disclosed are a high speed wide range RFID tag capable of improving a data transmission speed and a recognition distance between an RFID tag and an RFID reader by controlling a reflected power as multi levels through adjustment of a reflection coefficient in the RFID tag, and a method of controlling the same. The RFID tag includes a data converting unit configured to convert stored RFID serial tag data into a number of multi-level parallel data according to a request of an RFID reader, a reflection coefficient adjusting unit configured to generate a plurality of reflection coefficients corresponding to a number of the converted parallel data, and a transmitting unit configured to transmit a number of the multi-level parallel data according to the generated plurality of tag reflection coefficients through an antenna to the RFID reader.

### CROSS-REFERENCE TO RELATED APPLICATION

This application claims priority to and the benefit of Korean Patent Application No. 10-2016-0000652, filed on Jan. 4, 2016, the disclosure of which is incorporated herein by reference in its entirety.

### BACKGROUND

1. Field of the Disclosure

The present invention relates to a technology for a radio-frequency identification (RFID) tag and a method of controlling the same, and more particularly, to a high speed wide range RFID tag capable of improving a data transmission speed and a recognition distance between an RFID tag and an RFID reader by controlling reflected power as multi-levels through adjustment of a reflection coefficient at the RFID tag, and a method of controlling the same.

2. Discussion of Related Art

In general, RFID technology is a technology in which a tag is attached to each object to identify a unique identifier (ID) of the object in a wireless manner and collect, store, process and track relevant information, thereby providing various services, such as positioning, remote processing, management and information exchange between the objects.

Such a technology does not require direct touch and scanning in a visible area, unlike the existing barcode, and due to these benefits, is evaluated as a technology alternative of the barcode, and thus increasingly used in various fields.

Meanwhile, such an RFID system is divided into an inductively coupled method and an electromagnetic wave method depending on interactive communication between a reader and a tag, is divided into a battery-supported type and a passive type depending on whether a tag operates by its own power, and is divided into a low frequency range system and a high frequency range system depending on an operating frequency.

A low frequency band RFID system (30 kHz to 500 kHz) is used for transmission in a short distance of 1.8 m or less, and a high frequency band RFID system (850 MHz to 950 MHz or 2.45 GHz to 2.5 GHz) is used for transmission in a wide range of about 10 m or above. In other words, the RFID system is a system for identifying information about an RFID tag existing within a range of about several meters by connecting an antenna to an RFID reader and processing the data.

Hereinafter, a general RFID system will be briefly described with reference to FIG. 1. FIG. 1 is a view illustrating a configuration of the general RFID system.

Referring to FIG. 1, the RFID system includes an RFID reader and an RFID tag.

For communication in a UHF band RFID system (900 MHz), the RFID tag performs communication with an RFID reader using a backscattering-based load modulation method. The backscattering-based load modulation method represents a method in which an RFID tag scatters and returns electromagnetic waves transmitted from an RFID reader to the RFID reader such that information about the RFID tag is transmitted with a changed magnitude or phase of the scattered electromagnetic waves, that is, a modulation method in which information is included in a carrier signal received from the RFID reader by adjusting an impedance of an RFID tag antenna and is transmitted.

In general, the RFID tag signal transmission method using load modulation includes changing the reflected power by switching a load impedance of an RFID tag into two states (Z1, Z2) as shown in FIG. 1.

That is, for communication between an RFID tag and an RFID reader in the conventional UHF band RFID system, 1 bit is included in one symbol, which leads to inefficiency of data transmission speed of the RFID tag, compared to pulse amplitude modulation(PAM) (multi bits/symbol) having multi-levels.

### SUMMARY OF THE INVENTION

The present invention is directed to technology for a high speed wide range RFID tag capable of improving a data transmission speed and a recognition range between an RFID tag and an RFID reader by controlling the reflected power as multi-levels through adjustment of a reflection coefficient at the RFID tag, and a method of controlling the same.

In accordance with one aspect of the present invention, there is provided a radio frequency identification (RFID) tag including a data converting unit, a reflection coefficient adjusting unit, and a transmitting unit. The data converting unit may be configured to convert stored RFID serial tag data into a number of multi-level parallel data according to a request of an RFID reader. The reflection coefficient adjusting unit may be configured to generate a plurality of reflection coefficients corresponding to a number of the converted parallel data. The transmitting unit may be configured to transmit a number of the multi-level parallel data according to the generated plurality of tag reflection coefficients through an antenna to the RFID reader.

The RFID tag may further include a bias voltage generating unit configured to generate bias voltages mapped to a number of the parallel data to generate the reflection coefficients from the reflection coefficient adjusting unit.

The reflection coefficient adjusting unit may use an element of which a negative resistant value varies according to the bias voltage generated from the bias voltage generating unit.

The element may use at least one of a transistor and a GUNN diode.

When the RFID tag is a passive RFID tag, the bias voltage may be generated by rectifying power transmitted from the RFID reader.

When the RFID tag is a battery supported RFID tag, the bias voltage may be obtained from a battery attached to the RFID tag.

In accordance with another aspect of the present invention, there is provided an RFID tag including a data converting unit, a bias voltage generating unit, a variable amplifying unit, and a transmitting unit. The data converting unit may be configured to convert stored RFID serial tag data into a number of multi-level parallel data according to a request of an RFID reader. The bias voltage generating unit may be configured to generate bias voltages that are mapped to a number of the multi-level parallel data. The variable amplifying unit may be configured to generate a multi-level tag reflection signal by amplifying the generated bias voltage. The transmitting unit may be configured to transmit the tag data carried on the multi-level tag reflection signal amplified by the variable amplifier to the RFID reader.

The variable amplifying unit may amplify the tag reflection signal to have a different level according to the bias voltage generated by the bias voltage generating unit.

When the RFID tag is a passive RFID tag, the bias voltage may be generated by rectifying power transmitted from the RFID reader, and when the RFID tag is a battery supported RFID tag, the bias voltage may be obtained from a battery attached to the RFID tag.

In accordance with another aspect of the present invention, there is provided a method of controlling a radio frequency identification (RFID) tag, the method including: converting stored RFID serial tag data into a number of multi-level parallel data according to a request of an RFID reader; generating a plurality of reflection coefficients corresponding to a number of the converted parallel data; and transmitting a number of the multi-level parallel data according to the generated plurality of tag reflection coefficients through an antenna to the RFID reader.

The method may further include generating bias voltages that are mapped to a number of the parallel data to generate the reflection coefficients.

The reflection coefficient may be generated using a characteristic in which a negative resistant value varies according to the generated bias voltage.

The generating of the reflection coefficient element may include generating the reflection coefficient element using at least one of a transistor and a GUNN diode.

When the RFID tag is a passive RFID tag, the bias voltage may be generated by rectifying power transmitted from the RFID reader, and when the RFID tag is a battery supported RFID tag, the bias voltage may be obtained from a battery attached to the RFID tag.

In accordance with another aspect of the present invention, there is provided a method of controlling an RFID tag, the method including: converting stored RFID serial tag data into a number of multi-level parallel data according to a request of an RFID reader; generating bias voltages that are mapped to a number of the parallel data; generating a multi-level tag reflection signal by amplifying the generated bias voltage; and transmitting the tag data carried on the amplified multi-level tag reflection signal to the RFID reader.

In the generating of the tag reflection signal, a level of the tag reflection signal may be amplified to be different according to the generated bias voltage.

When the RFID tag is a passive RFID tag, the bias voltage may be generated by rectifying power transmitted from the RFID reader, and when the RFID tag is a battery supported RFID tag, the bias voltage may be obtained from a battery attached to the RFID tag.

### BRIEF DESCRIPTION OF THE DRAWINGS

The above and other objects, features and advantages of the present invention will become more apparent to those of ordinary skill in the art by describing in detail embodiments thereof with reference to the accompanying drawings, in which:

FIG. 1 is a diagram illustrating a configuration of a general RFID system;

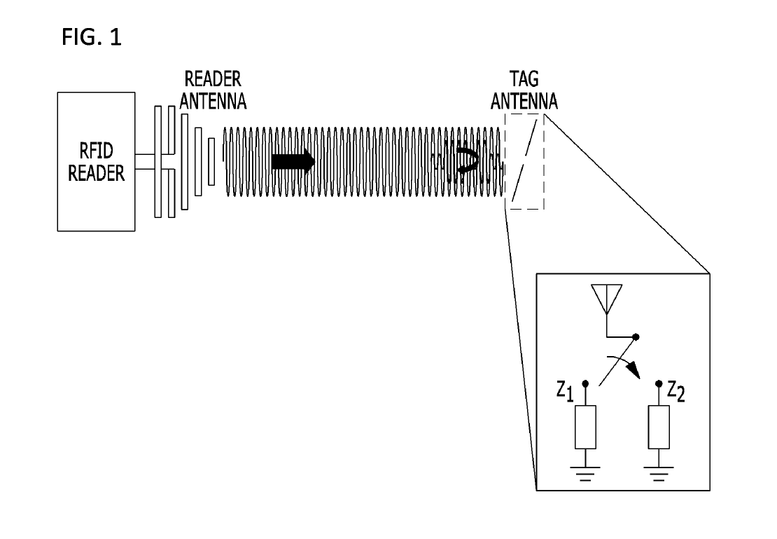

FIG. 2 is a diagram for describing PAM signals at multi-levels;

FIG. 3 is a block diagram illustrating an internal configuration of an RFID tag according to a first embodiment of the present invention;

FIG. 4 is a diagram for describing a reflection coefficient of a general RFID tag;

FIG. 5 is a diagram illustrating an example of a reflection coefficient adjusting unit in the RFID tag according to the first embodiment of the present invention shown in FIG. 3;

FIG. 6 is a diagram illustrating a simulation result of the reflection coefficient adjusting unit in the RFID tag according to the embodiment of the present invention;

FIG. 7 is a diagram illustrating a simulation result of an RFID tag signal received by an RFID reader according to the present invention;

FIG. 8 is a diagram illustrating another example of the reflection coefficient adjusting unit according to the first embodiment of the present invention shown in FIG. 3; and

FIG. 9 is a block diagram illustrating an internal configuration of an RFID tag according to another embodiment of the present invention.

### DETAILED DESCRIPTION OF EMBODIMENTS

The above objects and other advantages, and a scheme for the advantages of the present invention will become readily apparent by reference to the following detailed description when considered in conjunction with the accompanying drawings. However, the scope of the present invention is not limited to such embodiments and the present invention may be realized in various forms. The embodiments to be described below are merely embodiments provided to fully disclose the present invention and assist those skilled in the art to completely understand the present invention, and the present invention is defined only by the scope of the appended claims. The specification drafted as such is not limited to detailed terms suggested in the specification. The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof

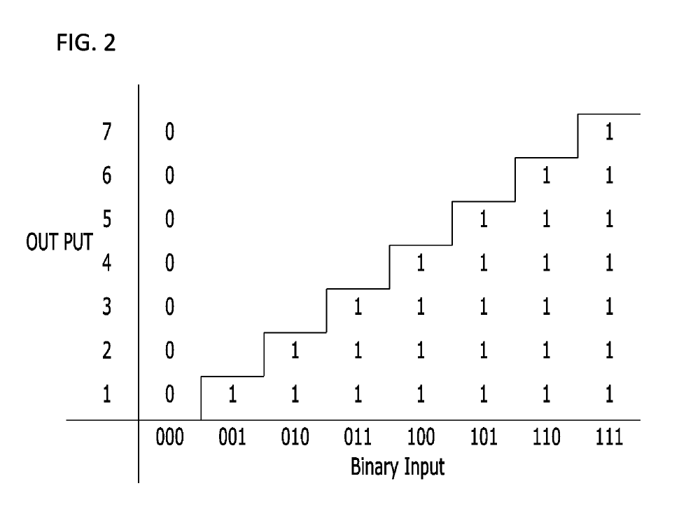

In order to describe the configuration and operation of an RFID tag according to an embodiment of the present invention, the objective and effects of the present invention will be briefly described with reference to FIG. 2. FIG. 2 is a diagram for describing PAM signals at multi levels.

As illustrated in FIG. 2, the present invention uses one symbol including a binary signal having 3 bits, and this may improve a e transmission speed to at least three or more times a transmission speed of an existing RFID communication method using one symbol having one bit.

The RFID tag according to the present invention controls reflected power as in multi levels through adjustment of reflection coefficients, thereby improving a data transmission speed between a tag and a reader and improving a recognition distance. In addition, the RFID tag according to the present invention amplifies a tag backscatter signal to multi levels, thereby improving the data transmission speed between the tag and the reader and improving the recognition distance.

Hereinafter, an embodiment of an RFID tag according to the present invention and a method of controlling the RFID tag will be described with reference to the accompanying drawings in detail.

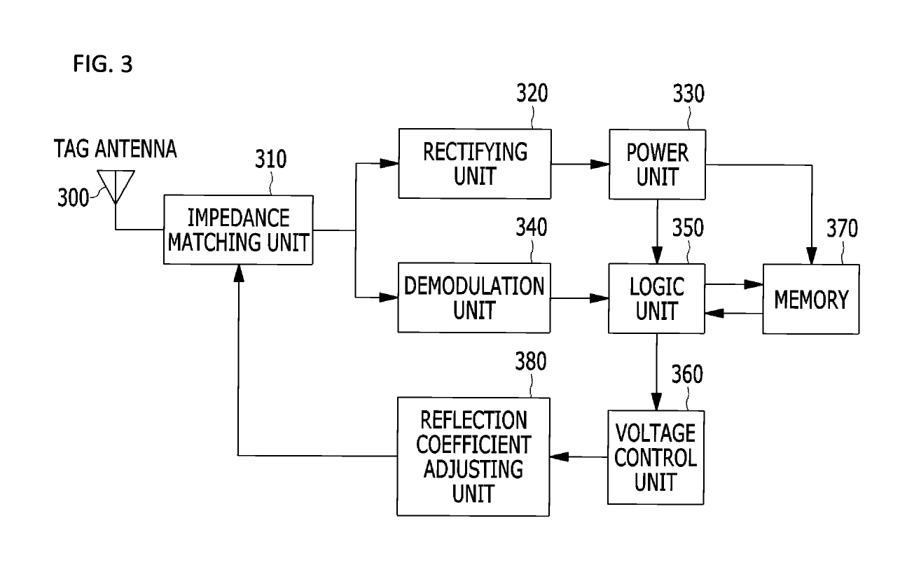

FIG. 3 is a block diagram illustrating a configuration of an RFID tag according to a first embodiment of the present invention.

First, a general passive RFID tag scatters electromagnetic waves transmitted from an RFID reader and returns tag information to the RFID reader, and to this end, an impedance of a tag antenna varies. The variation of impedance of the tag antenna is achieved by switching an impedance value of a modulator in the tag, and in general, a load impedance of the tag has two states.

As shown in FIG. 3, an RFID tag according to the embodiment of the present invention includes a tag antenna 300, an impedance matching unit 310, a rectifying unit 320, a power unit 330, a demodulation unit 340, a logic unit 350, a voltage control unit 360, a memory 370 and a reflection coefficient adjusting unit 380.

In contrast to the above-described general passive RFID tag, the RFID tag according to the present invention returns tag information through the reflection coefficient adjusting unit 380, and the intensity of a backscattering signal is adjusted by the voltage control unit 360. Here, the tag antenna 300, the impedance matching unit 310, the rectifying unit 320, the power unit 330, the demodulation unit 340, and the memory 370 may be the same as those included in the existing passive RFID tag or an existing battery supported RFID tag, and the logic unit 350, the voltage control unit 360, the reflection coefficient adjusting unit 380 may be different according to the present invention.

The impedance matching unit 310 performs impedance matching for transmitting and receiving signals between the tag antenna 300 and the RFID reader, and provides an RF signal received through the tag antenna 300 to the rectifying unit 320 and the demodulation unit 340 after the impedance matching. The impedance matching unit 310 transmits encoded tag data corresponding to a command of the RFID reader to the RFID reader through the tag antenna 300 with amounts of RF power at multi levels that is converted by the reflection coefficient adjusting unit 380.

The rectifying unit 320 converts RF power received from the RFID reader through the tag antenna 300 and the impedance matching unit 310 into a direct current (DC) voltage, and provides the converted DC voltage to the power unit 330. Here, the rectifying unit 320 may include a diode and a capacitor.

The power unit 330 is configured to supply the DC voltage provided from the rectifying unit 320 as a power source for driving each block in the RFID tag, and in general, includes a capacitor.

Meanwhile, when the RFID tag according to the embodiment of the present invention is a battery supported RFID tag, the rectifying unit 320 and the power unit 330 may be implemented using an additional battery.

The demodulation unit 340 demodulates a command of the RFID reader received through the impedance matching unit 310, and provides the demodulated command of the RFID reader to the logic unit 350.

The logic unit 350, in response to the RFID command provided from the demodulation unit 340, reads tag data corresponding to the RFID command from the memory 370, encodes the read tag data, and provides the encoded tag data to the voltage control unit 360.

The voltage control unit 360 generates a bias voltage corresponding to the tag data provided from the logic unit 350, and provides the reflection coefficient adjusting unit 380 with the bias voltage along with the tag data

The reflection coefficient adjusting unit 380 converts the intensity of a backscattering reflection signal to multi levels according to the bias voltage provided from the voltage control unit 360 to achieve high speed wide range communication, and loads the encoded tag data carried on the converted multi-level backscattering reflection signal to be transmitted to the RFID reader through the tag antenna 300.

That is, since the RFID tag according to the embodiment of the present invention represents multi-level tag data information using one symbol, and varies reflected power as multi levels through the reflection coefficient adjusting unit 380 according to a control of a bias voltage applied through the voltage control unit 360, multi bits may be transmitted using one symbol, and thus the transmission speed can be improved. In addition, the reflection coefficient may be adjusted to be greater than 1, thereby improving a recognition distance compared to the existing passive RFID system.

To this end, the logic unit 350 in the high speed wide range tag previously recognizes bias voltage mapping information to be applied to the reflection coefficient adjusting unit 380, and provides the bias voltage to the reflection coefficient adjusting unit 380 through the voltage control unit 360.

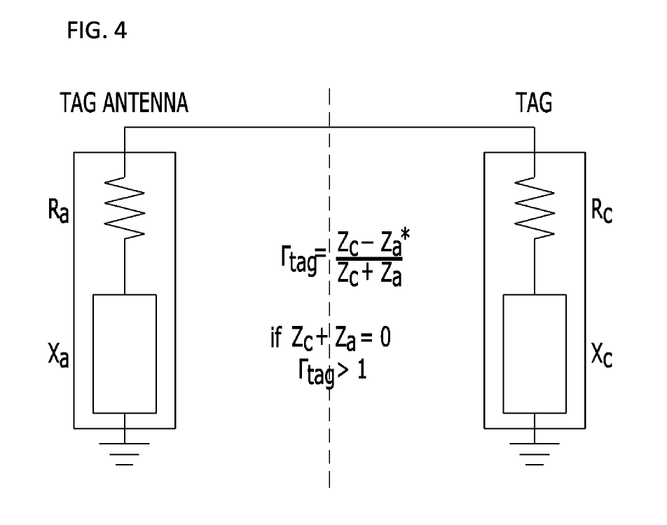

Hereinafter, a reflection coefficient will be described with reference to FIG. 4. FIG. 4 is a diagram for describing a reflection coefficient of a general RFID tag;

A reflection coefficient is a ratio of a reflected voltage to an input voltage, and in general, is in a range of 0<Γ<1. However, as illustrated in FIG. 4, when the sum of an antenna impedance Zₐ and a tag impedance Z_{c} is 0, a reflection coefficient Γ_{tag} has a value greater than 1. To this end, the RFID tag needs to have a negative resistance value.

The following description will be made in relation to detailed embodiments of adjusting a reflection coefficient using a negative resistance characteristic of the same RFID tag, that is, embodiments of allowing the reflection coefficient adjusting unit 380 shown in FIG. 3 to implement a negative resistance characteristic.

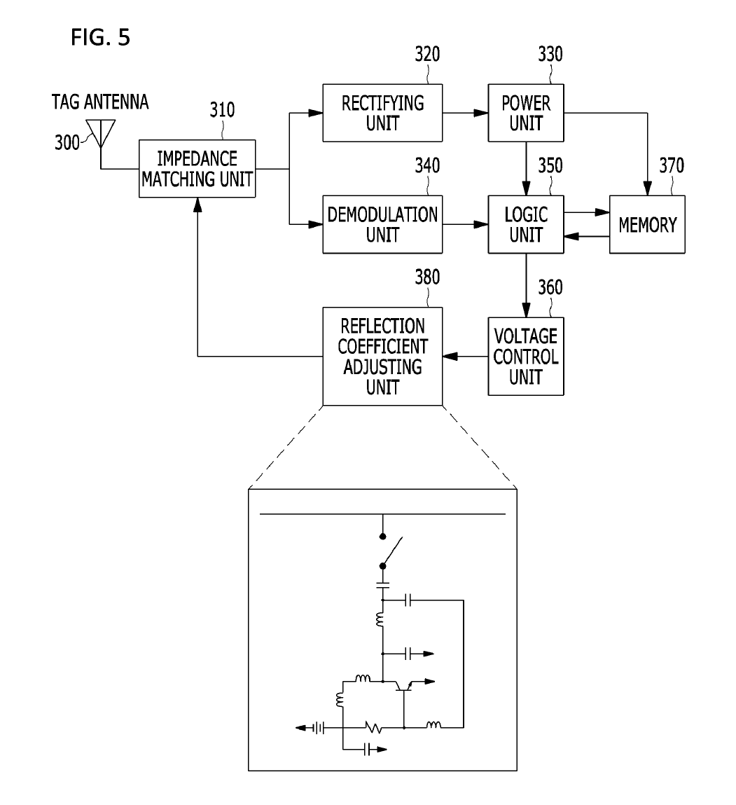

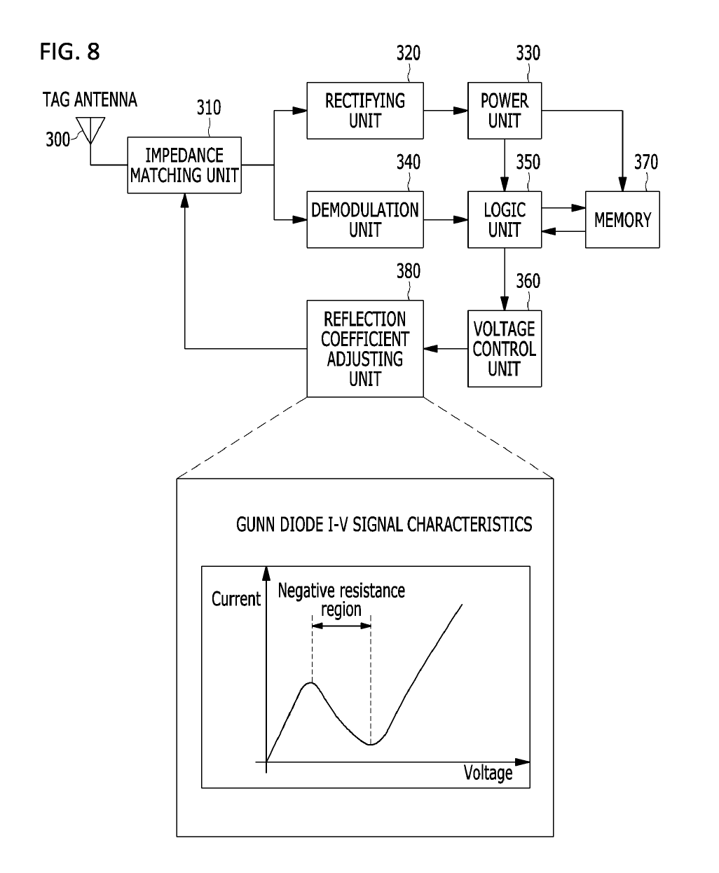

FIG. 5 is a diagram illustrating an example of the reflection coefficient adjusting unit in an RFID tag according to a first embodiment of the present invention shown in FIG. 3, and FIG. 8 is a diagram illustrating another example of the reflection coefficient adjusting unit according to the first embodiment of the present invention shown in FIG. 3. Since each of the overall configurations of FIGS. 5 and 8 is the same as that of FIG. 3, a detailed description of the configuration is omitted, and only an operation of the reflection coefficient adjusting unit 380 will be described.

First, as illustrated in FIG. 5, the reflection coefficient adjusting unit 380 uses an oscillator having a negative resistance characteristic, and the oscillator forms an unstable condition using a bipolar junction transistor (BJT) or field effect transistor (FET), and is composed of a feedback network and a resonator to generate a negative resistance condition.

Meanwhile, the reflection coefficient adjusting unit 380 according to another embodiment of the present invention may use a GUNN diode having a negative resistance characteristic as shown in FIG. 8. That is, as illustrated in FIG. 8, when a forward voltage is applied to the GUNN diode, a high current (a peak current) flows rapidly, but as a voltage increases, a region having a decrease in current is generated. As a voltage increases further, current is increased in proportion to the voltage. Such a negative resistance region enables a great change in current with a small change of voltage. By using such a characteristic, the reflection coefficient adjusting unit 380 suggested by the embodiment of the present invention may be provided.

Although the reflection coefficient adjusting unit 380 having the negative resistance characteristic has been illustrated using the BJT or the FET and the GUNN diode in FIGS. 5 and 8, various negative resistance circuits or negative resistance elements having negative resistance characteristics may be used.

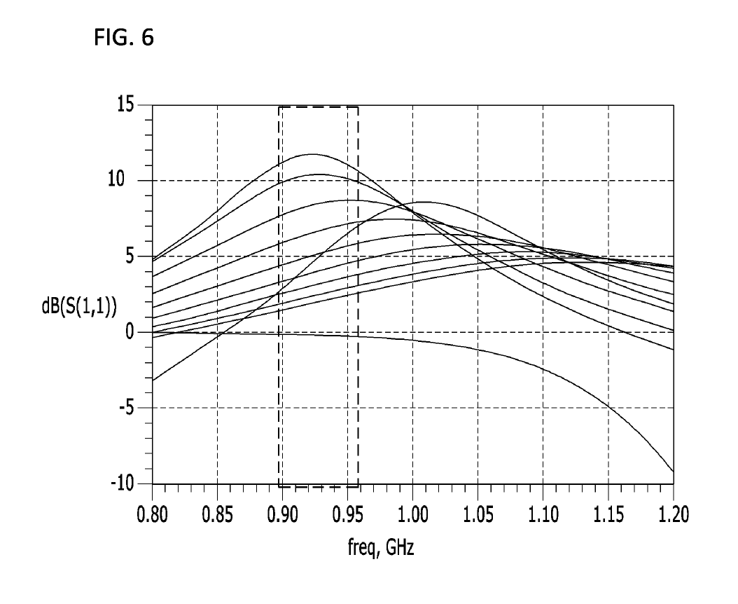

The following description will be made in relation to a simulation result obtained using the negative resistance characteristic of the reflection coefficient adjusting unit 380 in the RFID tag with reference to FIG. 6. FIG. 6 is a simulation result of a reflection coefficient adjusting unit in the high speed wide range RFID tag according to an embodiment of the present invention.

Referring to the simulation result of FIG. 6, a scattering parameter (S-parameter) in a frequency band of 900 MHz varies according to an applied bias voltage, and it shows that values greater than 0 occur. This result shows that the intensity of reflected signals of the RFID tag according to the embodiment of the present invention is greater than that of the existing passive RFID tag, and thus the recognition distance between the RFID tag and RFID reader can be increased.

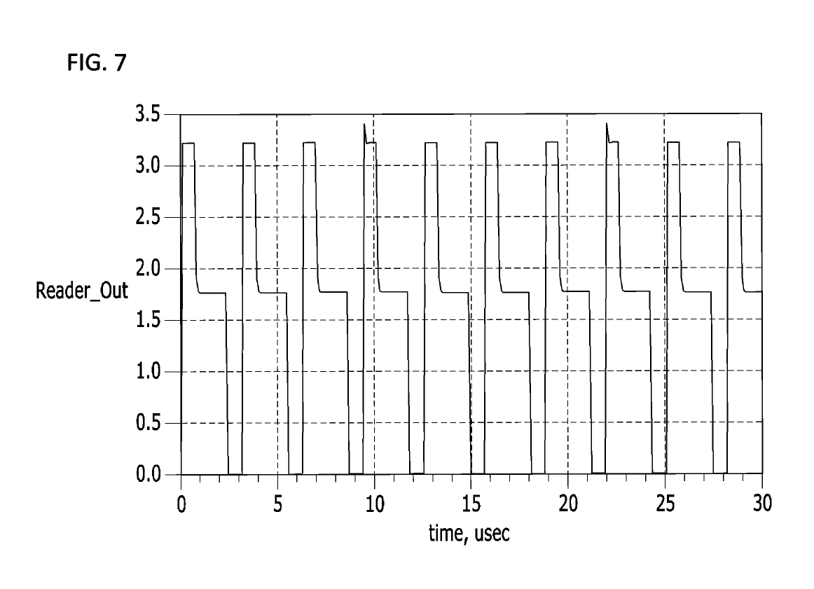

FIG. 7 illustrates a reception result of RFID reader for a tag signal transmitted from the RFID tag according to the above described method. Here, FIG. 7 is a simulation result of a high speed wide range RFID tag signal received by the RFID reader according to the embodiment of the present invention.

As illustrated in FIG. 7, the tag signal to be demodulated in the RFID reader is provided to have three stages, and this shows that one symbol having a 2 bit signal is able to be transmitted.

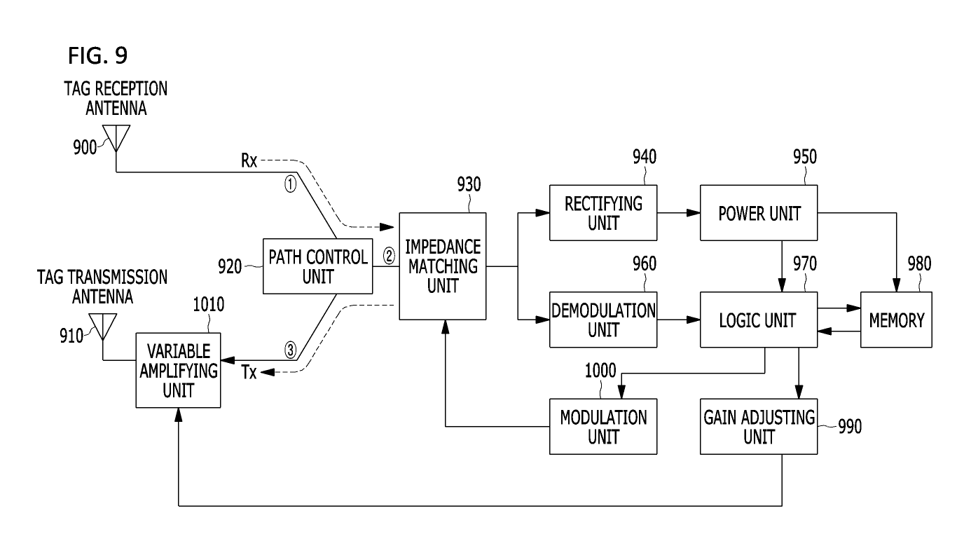

FIG. 9 is a block diagram illustrating a configuration of an RFID tag according to a second embodiment of the present invention.

As illustrated in FIG. 9, an RFID tag according to the second embodiment of the present invention is largely divided into a tag antenna unit and a tag system unit.

The tag antenna unit includes a tag reception antenna 900 and a tag transmission antenna 910.

The tag system unit includes a path control unit 920, an impedance matching unit 930, a rectifying unit 940, a power unit 950, a demodulation unit 960, a logic unit 970, a memory 980, a gain adjusting unit 990, a modulation unit 1000, and a variable amplifying unit 1010. The impedance matching unit 930, the rectifying unit 940, the power unit 950, and the demodulation unit 960 have the same configurations and operations as those described in the first embodiment of the present invention shown in FIG. 3, and thus detailed description thereof will be omitted.

First, a signal transmitted from the RFID reader is provided to the logic unit 970 through the tag reception antenna 900, the path control unit 920, the impedance matching unit 930 and the demodulation unit 960.

When a signal transmitted from the RFID reader is input to port \textcircled{1}, the path control unit 920 controls a path such that power is transmitted only to one of ports \textcircled{2} and \textcircled{3} without being transmitted to the other port.

That is, during the reception operation of the tag, a command signal transmitted from the RFID reader is provided to the demodulation unit 960 sequentially through port \textcircled{2} of the path control unit 920 and the impedance matching unit 930, without being transmitted to port \textcircled{3}.

Meanwhile, during the transmission operation of the tag, a tag signal to be transmitted to the RFID reader is not transmitted to port \textcircled{1} of the path control unit 920, and is transmitted to the variable amplifying unit 1010 through port\textcircled{3}. The path control unit 920 is composed of a circulator or RF switch. When the path control unit 920 is provided using a circulator, a signal is transmitted with a directivity as if the signal rotates in one direction, and when the path control unit 920 is provided using an RF switch, RF switches are disposed at port \textcircled{2} and port \textcircled{3}, respectively, and are independently operated to perform a path control for processing the above-described signal transmission and reception.

The impedance matching unit 930 performs impedance matching between the path control unit 920 and the demodulation and modulation units 960 and 1000. Herein, a signal input to the demodulation unit 960 through the impedance matching unit 930 includes an electromagnetic wave signal and a baseband signal, and the electromagnetic wave signal includes a continuous wave (a sine wave) transmitted from the RFID reader, and the baseband signal includes an RFID reader command.

The demodulation unit 960 demodulates the baseband signal of the RFID reader received through the tag reception antenna 900, and provides the logic unit 970 with the demodulated baseband signal.

The logic unit 970 deciphers the demodulated RFID reader's command provided from the demodulation unit 960, and reads tag data corresponding to the command from the memory 980. That is, the logic unit 970 reads tag information stored in the tag memory 980, for example, a unique identification code or unique identification information about an object, and provides the demodulation unit 960 with the read tag information as a signal responding to the RFID reader command.

The modulation unit 1000 switches the tag signal provided from the logic unit 970 to change an impedance of the tag. The magnitude of a backscattered electromagnetic wave is changed by the change of the tag impedance. The magnitude is transmitted to the reader, and the reader analyzes the transmitted tag data.

Meanwhile, the gain adjusting unit 990 adjusts a gain to variably amplify a tag signal transmitted to the RFID reader through the tag transmission antenna 910 according to control of the logic unit 970, and provides a gain signal to the variable amplifying unit 1010.

The variable amplifying unit 1010 generates a multilevel tag backscattering signal by amplifying a signal according to the gain value adjusted by the gain adjusting unit 990. Herein, since the multi-level tag signal may have one symbol having a number of bit information, high speed data transmission can be achieved. In addition, since the backscattering signal is amplified through the variable amplifying unit 1010, wide range data transmission can be achieved.

Accordingly, the tag signal modulated in the modulation unit 1000 may be carried on the multi-level backscattering signal amplified through the variable amplifying unit 1010, and transmitted to the RFID reader through the tag transmission antenna 910.

As is apparent from the above, the existing UHF band RFID tag transmits data of the tag by switching a load impendence between two states (match and mismatch) such that reflected power is changed, whereas according to the embodiment of the present invention, one symbol having multi bits can be transmitted by adjusting a reflection coefficient during RFID tag modulation such that reflected power is changed as multi-levels, and thus the transmission speed can be improved. In addition, the reflection coefficient is adjusted to be greater than 1 using a negative resistance characteristic, and thereby a recognition distance can be improved more than the existing passive RFID system.

Although the RFID tag and the method of controlling the same according to the present invention have been described above, it should be understood that there is no intent to limit the present invention to the particular forms disclosed, but on the contrary, the disclosure is to cover all modifications, equivalents, and alternatives falling within the spirit and scope of the disclosure.

Therefore, the embodiments disclosed in the present invention and the accompanying drawings are not intended to limit but illustrate the technical spirit of the present invention, and the scope of the present invention is not limited by the embodiments and the accompanying drawings. The protection scope of the present invention shall be construed on the basis of the accompanying claims and it shall be construed that all of the technical ideas included within the scope equivalent to the claims belong thereto.

What is claimed is:

1. A radio frequency identification (RFID) tag comprising:
a data converting unit configured to convert stored RFID serial tag data into a number of multi-level parallel data according to a request of an RFID reader;
a reflection coefficient adjusting unit configured to generate a plurality of reflection coefficients corresponding to a number of the converted multi-level parallel data; and
a transmitting unit configured to transmit a number of the multi-level parallel data according to the generated plurality of tag reflection coefficients through an antenna to the RFID reader.

2. The RFID tag of claim 1, further comprising a bias voltage generating unit configured to generate bias voltages mapped to a number of the multi-level parallel data to generate the reflection coefficients from the reflection coefficient adjusting unit.

3. The RFID tag of claim 2, wherein the reflection coefficient adjusting unit uses an element of which a negative resistant value varies according to the bias voltage generated from the bias voltage generating unit.

4. The RFID tag of claim 3, wherein the element uses at least one of a transistor and a GUNN diode.

5. The RFID tag of claim 2, wherein when the RFID tag is a passive RFID tag, the bias voltage is generated by rectifying power transmitted from the RFID reader.

6. The RFID tag of claim 5, wherein when the RFID tag is a battery supported RFID tag, the bias voltage is obtained from a battery attached to the RFID tag.

7. A radio frequency identification (RFID) tag comprising:
a data converting unit configured to convert stored RFID serial tag data into a number of multi-level parallel data according to a request of an RFID reader;
a bias voltage generating unit configured to generate bias voltages mapped to a number of the multi-level parallel data;
a variable amplifying unit configured to generate a multi-level tag reflection signal by amplifying the generated bias voltage; and
a transmitting unit configured to transmit the tag data carried on the multi-level tag reflection signal amplified by the variable amplifier to the RFID reader.

8. The RFID tag of claim 7, wherein the variable amplifying unit amplifies the tag reflection signal to have a different level according to the bias voltage generated from the bias voltage generating unit.

9. The RFID tag of claim 7, wherein when the RFID tag is a passive RFID tag, the bias voltage is generated by rectifying power transmitted from the RFID reader, and when the RFID tag is a battery supported RFID tag, the bias voltage is obtained from a battery attached to the RFID tag.

10. A method of controlling a radio frequency identification (RFID) tag, the method comprising:
converting stored RFID serial tag data into a number of multi-level parallel data according to a request of an RFID reader;
generating a plurality of reflection coefficients corresponding to a number of the converted multi-level parallel data; and
transmitting a number of the multi-level parallel data according to the generated plurality of tag reflection coefficients through an antenna to the RFID reader.

11. The method of claim 10, further comprising generating bias voltages that are mapped to a number of the multi-level parallel data to generate the reflection coefficients.

12. The method of claim 11, wherein the reflection coefficient is generated using a characteristic in which a negative resistant value varies according to the generated bias voltage.

13. The method of claim 12, wherein the generating of the reflection coefficient element includes generating the reflection coefficient element using at least one of a transistor and a GUNN diode.

14. The method of claim 10, wherein when the RFID tag is a passive RFID tag, the bias voltage is generated by rectifying power transmitted from the RFID reader.

15. The method of claim 14, wherein when the RFID tag is a battery supported RFID tag, the bias voltage is obtained from a battery attached to the RFID tag.

16. A method for controlling a radio frequency identification (RFID) tag, the method comprising:
converting stored RFID serial tag data into a number of multi-level parallel data according to a request of an RFID reader;
generating bias voltages that are mapped to a number of the multi-level parallel data;
generating a multi-level tag reflection signal by amplifying the generated bias voltage; and
transmitting the tag data carried on the amplified multi-level tag reflection signal to the RFID reader.

17. The method of claim 16, wherein, in the generating of the tag reflection signal, a level of the tag reflection signal is amplified to be different according to the generated bias voltage.

18. The method of claim 17, wherein when the RFID tag is a passive RFID tag, the bias voltage is generated by rectifying power transmitted from the RFID reader.

19. The method of claim 18, wherein when the RFID tag is a battery supported RFID tag, the bias voltage is obtained from a battery attached to the RFID tag.
